(19) United States
(12) Patent Application Publication
(10) Pub. No.: US 2018/0046330 A1
(43) Pub. Date: Feb. 15, 2018

(54) INTERFACE MENU PRESENTING NON-INSTALLED CONTENT SHARING APPLICATIONS

(71) Applicant: Microsoft Technology Licensing, LLC, Redmond, WA (US)

(72) Inventors: Paula Chuchro, Seattle, WA (US); Chee Chen Tong, Kirkland, WA (US); Kevin Hill, Redmond, WA (US); Anirudh Agarwal, Redmond, WA (US); Dayanand Balasubramanian, Seattle, WA (US); Michael Allen Seibert, Redmond, WA (US); Lavanya Vasudevan, Sammamish, WA (US); Prasad Pradeep Korhale, Kirkland, WA (US)

(21) Appl. No.: 15/235,842

(22) Filed: Aug. 12, 2016

(51) Int. Cl. G06F 3/0482; H04L 29/08

(52) U.S. Cl. CPC G06F 3/0482; H04L 67/02; H04L 67/22

(57) ABSTRACT

A model for presenting non-installed applications that enable the user to share the type of content that a user is accessing. For instance, the application might be a computing program, a web service, and so forth. The model may present both installed and not installed content sharing applications in a user interface menu. For a given user interface menu, there would be a list of visualizations, each of which is associated with one of the content sharing applications. The user may select one or more non-installed applications to share the content. Furthermore, the model may select the applications to be presented in the list based on a number of different factors; for instance, the location of the user, a language of the content, a web service the user accessed, an application that is installed by a user's contacts, and so forth.

### BACKGROUND

A computing system allows users to share content by using content sharing applications that are already installed on the computing system. For instance, a user may share a photo from the photo viewer by an installed image sharing application. For another instance, the user may share a video from a video viewer by logging into a social media web service.

A typical computing system provides an application catalog, such as an app store. The application catalog includes many other non-installed content sharing applications. When a user needs to share content from a non-installed application, the user can go to the application catalog and search for the application, then download and install it on the user's computing system.

The subject matter claimed herein is not limited to embodiments that solve any disadvantages, or that operate only in environments such as those described above. Rather, this background is only provided to illustrate one exemplary technology area where some embodiments described herein may be practiced.

### SUMMARY

At least some embodiments described herein relate to a model for presenting non-installed applications that enable the user to share the type of content that a user is accessing. For a given type of content that a user is accessing (e.g., audio, video, image, text, web page, web address, and so forth), the model identifies one or more applications that enable the user to share the content. A non-installed application may be, for instance, a web service. The model displays the applications in a user interface menu, whereupon the user may select one or more non-installed applications from the menu to share the content.

At least some embodiments described herein relate to the basis for selecting the non-installed applications to be presented in the user interface menu. The model may select the applications to be presented in the menu based on a number of different factors, such as, a location of the user, a language of the content, a web service the user accessed, an application that is installed by a user's contacts, and so forth. For instance, the model may select an application that corresponds to the location of the user and/or a language of the content. The model may also select an application that is installed by one or more contacts of the user. The model may also direct the user to the web service that the user previously accessed; and so forth.

Accordingly, the principles described herein allow for more sharing options to be provided to a user when deciding an application to use to share the content. Furthermore, the options are more likely to be suited to the interests of the user as the selection of additional target applications may be based on behavior of the user, and/or other factors that select the application in a more refined manner, regardless of whether the application is even installed on the user's computing system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not, therefore, to be considered to be limiting of the scope of the invention, the embodiments will be described and explained with additional specificity and detail through the use of the accompanying drawings in which:

FIG. 1 illustrates an example computing system in which the principle described herein may be employed;

FIG. 2 illustrates an environment in which a computing system shares accessed content via various applications (installed or non-installed) via a user interacting with visualizations on a user interface menu;

FIG. 3 illustrates multiple data flows originating with a variety of user information types;

FIG. 4 illustrates a general flow when a user previously accesses a web service;

FIG. 5 illustrates data flows associated with how previously stored user credential may be later used to facilitate automated access to a previously accessed web service when the web service is selected as a content sharing application;

FIG. 6 illustrates an environment in which a user interface menu is presented that includes visualizations of web services applications (both previously accessed and not accessed);

FIG. 7 illustrates an environment with an associated data flow showing how the computing system may obtain the contacts of the user, and then identify a list of the content sharing applications that are used by one or more of the user's contacts and enable sharing of content of the content type;

FIG. 8 illustrates that the computing system may obtain a location of the user, and then identify (from a collection of applications that are location registered) a list of the content sharing applications that enable sharing of content of the content type;

FIG. 9 illustrates that the computing system may obtain a language of the user, and then identify (from a collection of applications that are language registered) a list of the content sharing applications that enable sharing of content of the content type;

FIG. 10 illustrates data flows that show how the content accessing applications may include a functionality to influence the choice of content sharing applications; and

FIG. 11 illustrates an environment in which the computing system detects the type of content that the user is accessing, and further determines whether the type of the content is one of the types (e.g., audio, video, image, text, web page, web address, and so forth) for which the computing system enables content sharing.

### DETAILED DESCRIPTION

At least some embodiments described herein relate to a model for presenting non-installed applications that enable the user to share the type of content that a user is accessing. For a given type of content that a user is accessing (e.g., audio, video, image, text, web page, web address, and so forth), the model identifies one or more applications that enable the user to share the content. A non-installed application may be, for instance, a web service. The model displays the applications in a user interface menu, whereupon the user may select one or more non-installed applications from the menu to share the content.

At least some embodiments described herein relate to the basis for selecting the non-installed applications to be presented in the user interface menu. The model may select the applications to be presented in the list based on a number of different factors, such as, a location of the user, a language of the content, a web service the user accessed, an application that is installed by a user's contacts, and so forth. For instance, the model may select an application that corresponds to the location of the user and/or a language of the content. The model may also select an application that is installed by one or more contacts of the user. The model may also direct the user to the web service that the user previously accessed; and so forth.

Accordingly, the principles described herein allow for more sharing options to be provided to a user when deciding an application to use to share the content. Furthermore, the options are more likely to be suited to the interests of the user as the selection of additional target applications may be based on behavior of the user, and/or other factors that select the application in a more refined manner, regardless of whether the application is even installed on the user's computing system.

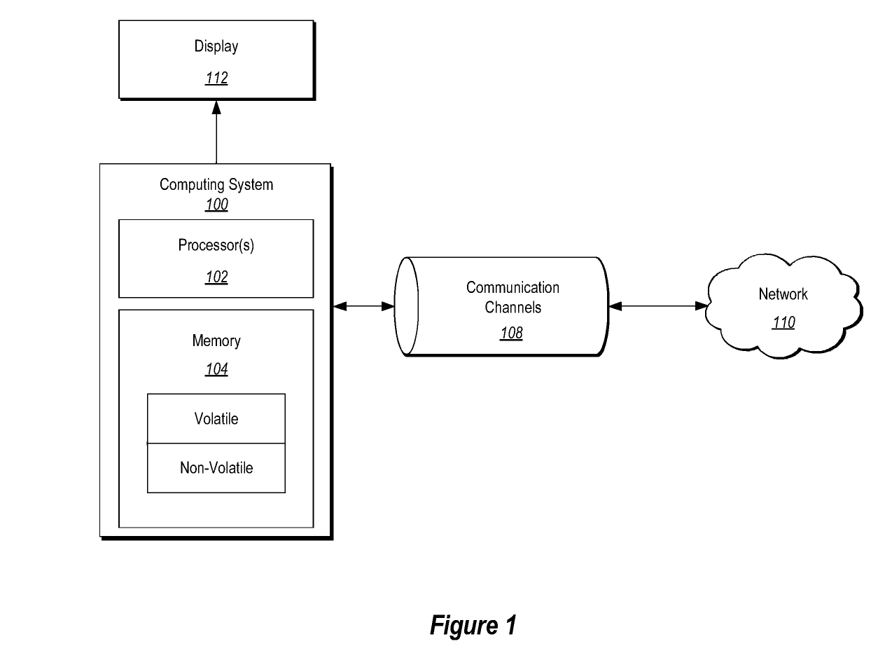

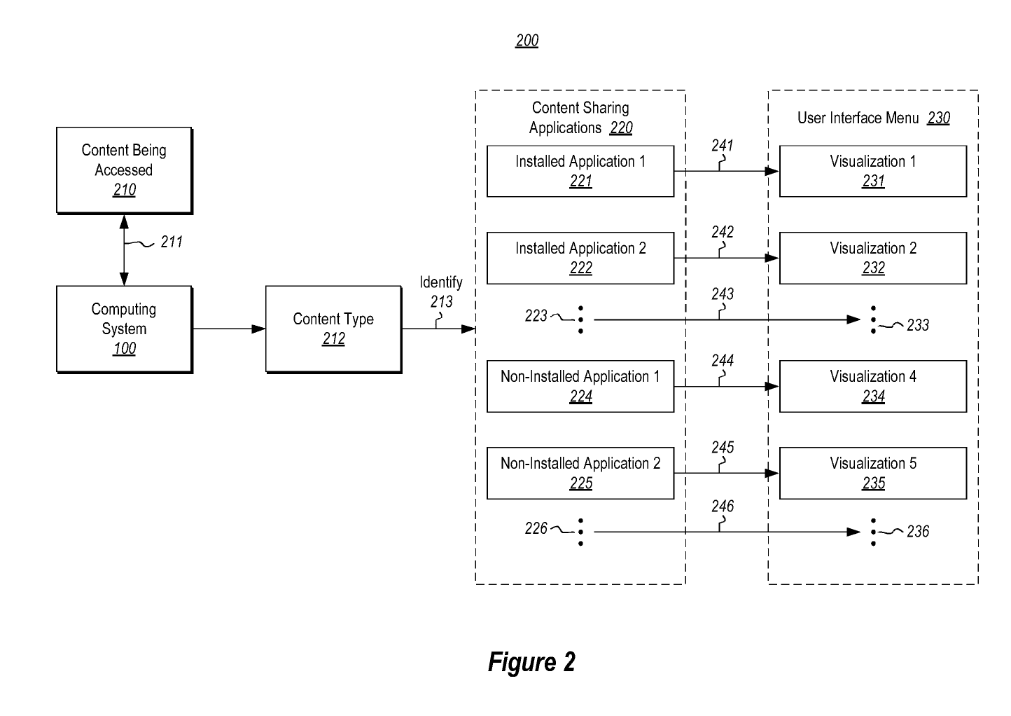

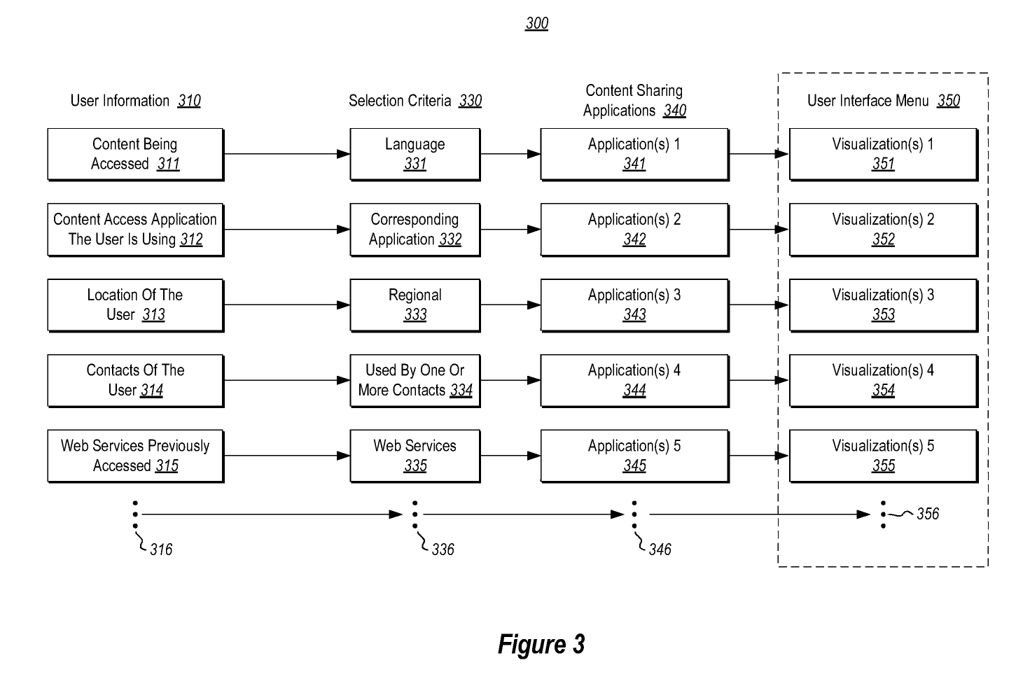

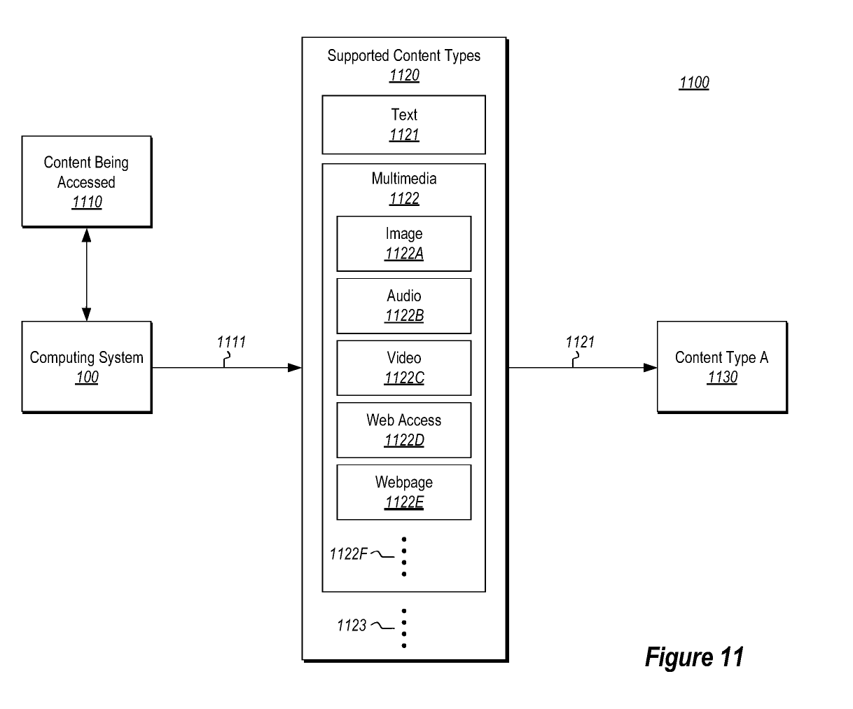

The principles described herein operate in the context of a computing system that presents the user multiple visualizations, a computing system will first be described with respect to FIG. 1. Furthermore, and thereafter, an environment in which the computing system shares accessed content via various applications will be described with respect to FIG. 2. Thereafter, further details regarding how the computing system identifies the multiple content sharing applications based on different criteria will be described with respect to FIG. 3 through 10. Finally, further details regarding how the computing system may support multiple content types for content sharing will be described with respect to FIG. 11.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems. An example computing system is illustrated in FIG. 1.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory, and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

The computing system 100 also includes a display 112 on which a user interface, such as the user interface visualizations here, may be rendered. Such user interface visualizations may be generated in computer hardware or other computer-represented form prior to rendering. The presentation and/or rendering of such user interfaces may be performed by the computing system 100 by having the processing unit(s) 102 execute one or more computer-executable instructions that are embodied on one or more computer-readable media. Such computer-readable media may form all or a part of a computer program product.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

A “network” is defined as one or more data links that enable the transport of electronic data between computer system and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments described herein relate to a user interface menu that presents one or more “non-installed” applications that enable a user to share content that the user is accessing. An application is a computing program that causes a computing system to perform tasks for users. An “installed” application is a computing program that has been installed and stored in the computing system. A user can initiate a task of an installed application by activating the installed computing program. An “non-installed” application is a computing program that has not been installed or stored in the computing system. A non-installed application may also be a web service.

As will be described herein, a computing system 100 presents a user interface on a display 112. The computing system may have one or more applications installed therein. The computing system includes an operating system, with the one or more installed applications running in the operating system. Even the operating system may also be considered as just an application that is installed on the computing system. An installed application may also be a launching point for navigating the web entering into other remote applications that perhaps are not even installed on the computing system. Such a remote non-installed application will also be referred to hereinafter as a “web service.”

FIG. 2 illustrates an environment 200 in which a computing system (such as the computing system 100 of FIG. 1) shares accessed content via various applications (installed or non-installed) via a user interacting with visualizations on a user interface menu 230. When a user accesses (as represented by bi-directional arrow 211) content, the computing system 100 detects (also as represented by bi-directional arrow 211) the type of the content 212 the user is accessing. Then, the system identifies (as represented by arrow 213) one or more applications 220 that enable the user to share the type of the content that the user is accessing. Such applications 220 may hereinafter be referred to as “content sharing applications”). At least one of the corresponding applications is a non-installed application. For instance, in FIG. 2, the applications 220 are illustrated as including installed applications 221 and 222 among potentially other numbers (zero, one, more or many more) as represented by the ellipses 223, and non-installed applications 224 and 225 among potentially other numbers (one, more or many more) as represented by the ellipses 226.

The computing system 100 presents a user interface menu 230 on the display 112. The menu 230 is populated with one or more visualizations, each of which being associated with one of the identified applications 220. For instance, the visualizations are illustrated as including visualization 231 through 236, each associated with respective applications 221 through 226. In particular, in the example that follows, assume that visualization 231 is associated with installed application 221 (as represented by line 241); visualization 232 is associated with installed application 222 (as represented by line 242); and so forth (as represented by ellipses 233 and the line 243. Similarly, assume that visualization 234 is associated with non-installed application 224 (as represented by line 244); visualization 235 is associated with non-installed application 225 (as represented by line 245); and so forth (as represented by the ellipses 236 and the line 246).

After the computing system 100 creates the user interface menu 230, the user may interact with one or more of the visualizations to activate the content sharing functionality of the corresponding application(s). When a user interacts with a visualization that is associated with a non-installed application, the computing system may perhaps install the non-installed application and enable the user to share content from the newly installed application. Alternatively, the computing system may direct the user to a web service that allows the user to share the content.

The act 213 of identifying a content sharing application illustrated in FIG. 2 could occur using one or more or all of the multiple selection criteria. As an example, FIG. 3 illustrates multiple data flows 300 originating with a variety of user information types, and in which content sharing applications 340 represent an example of content sharing applications 220 of FIG. 2, and user interface menu 350 represents an example of the user interface menu 230 of FIG. 2. For instance, in addition to identifying content sharing application(s) by content type, the computing system 100 could gather user information 310 from different sources and identify additional selection criteria when selecting the content sharing applications 340 to be populated in the user interface menu 350. Again, each of the identified content sharing applications 340 may be an installed or non-installed application.

A variety of additional criteria that are identified from user information is further illustrated in FIG. 3. In the example illustrated, each additional criteria is illustrated as being used to in the selection of a single content sharing application. Of course, this is just for purposes of example. Multiple of the illustrated additional criteria may be used to select any given content sharing application. Furthermore, any of the illustrated additional criteria may be used to select multiple content sharing application. However, for simplicity and clarity only, FIG. 3 illustrates different identifying criteria and content sharing applications in a one-to-one relationship. For instance, user information 310 may be the content being accessed by the user 311, the identity of the content access application the user is using 312, a location of the user 313, one or more contacts of the user 314, web services that the user previously accessed 315, and so forth 316. The ellipses 316 represent that there may be additional user information that can be used to generate identifying criteria.

As illustrated, the content being accessed by the user 311 helps the computing system identify a language 331 that was used in the content, which can then be used in identifying appropriate content sharing application(s) for that language. The identity of the content access application (i.e., the application that the user uses to access the content in the first place) the user is using 312 may be used by the computing system to help identify corresponding content sharing applications 332 that are especially suited for content accessed by the content access application. The location of the user 313 may help the computing system identify regional criteria of the user, which may be used to identifying corresponding applications 333 that are suited to that region (e.g., are popular or available within that region). The identity of one or more contacts of the user 314 may help the computing system identify content sharing applications that the contacts use 334, thereby more likely resulting in the computing system selecting those contact sharing application to share the accessed content. The identity of web services the user previously accessed (e.g., a navigation history) may help the computing system identify the user interests and web service information, and so forth, thereby allowing for a more intelligent selection of content sharing applications that the user is more familiar with.

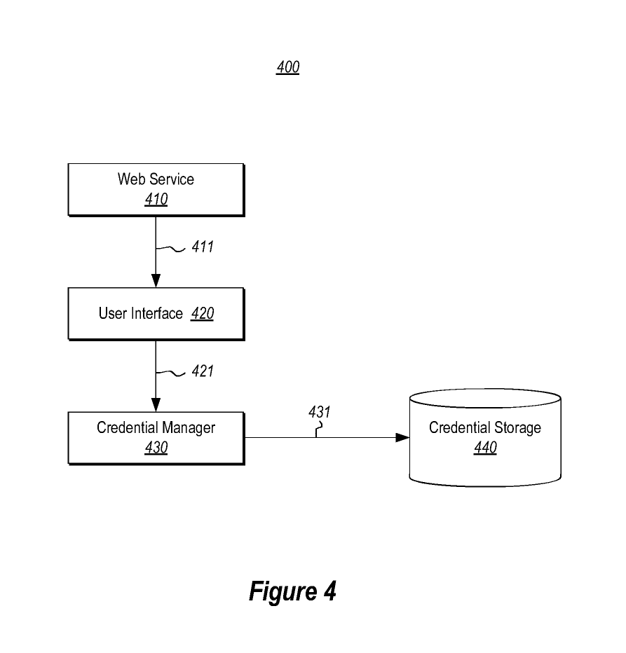

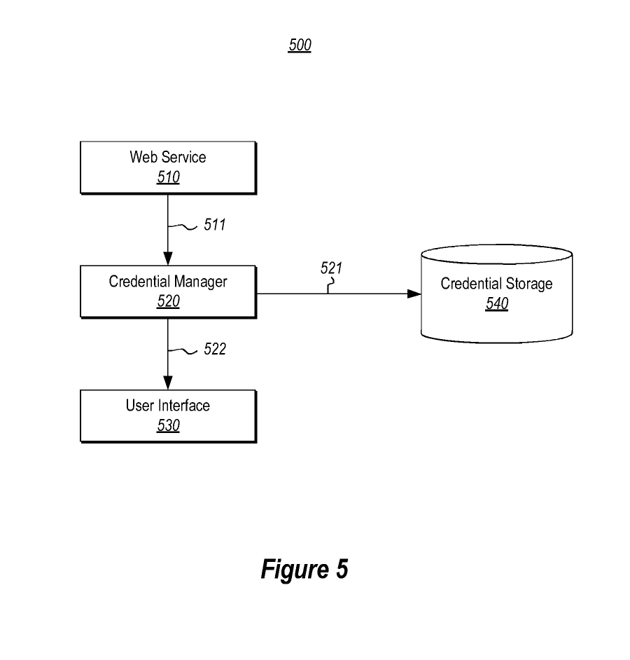

As mentioned above, a non-installed content sharing application may be a web service. As previously mentioned, the user may have accessed the web service previously, and the computing system may help the user gain access to that web service. FIGS. 4 and 5 illustrate examples of how this facilitation of access may be achieved by the computing system 100 tracking and storing the user login information used at the time the user accesses the web service. Later, if the user selects the web service as a content sharing application to share the content the user is accessing, the system 100 could retrieve the user login information and log in to the web service automatically.

FIG. 4 illustrates a general flow 400 when a user previously accesses a web service. As illustrated in FIG. 4, the user previously logs in (as represented by arrow 411) to the web service 410 through the user interface 420. A credential manager 430 tracks (as represented by arrow 421) the user's login information for that web service. The login information is stored (as represented by arrow 431) in a credential storage 440.

FIG. 5 illustrates data flows 500 associated with how this credential may be later used to facilitate automated access to the web service when the web service is selected as a content sharing application. As illustrated in FIG. 5, if the user selects a web service as a non-installed content sharing application to share accessed content, the credential manager identifies (as represented by arrow 511) that the web service was previously accessed, retrieves (as represented by arrow 521) the user login information from the credential storage 540, and then directs the user to the web service user interface 530 and logs in to the web service automatically (as represented by arrow 522).

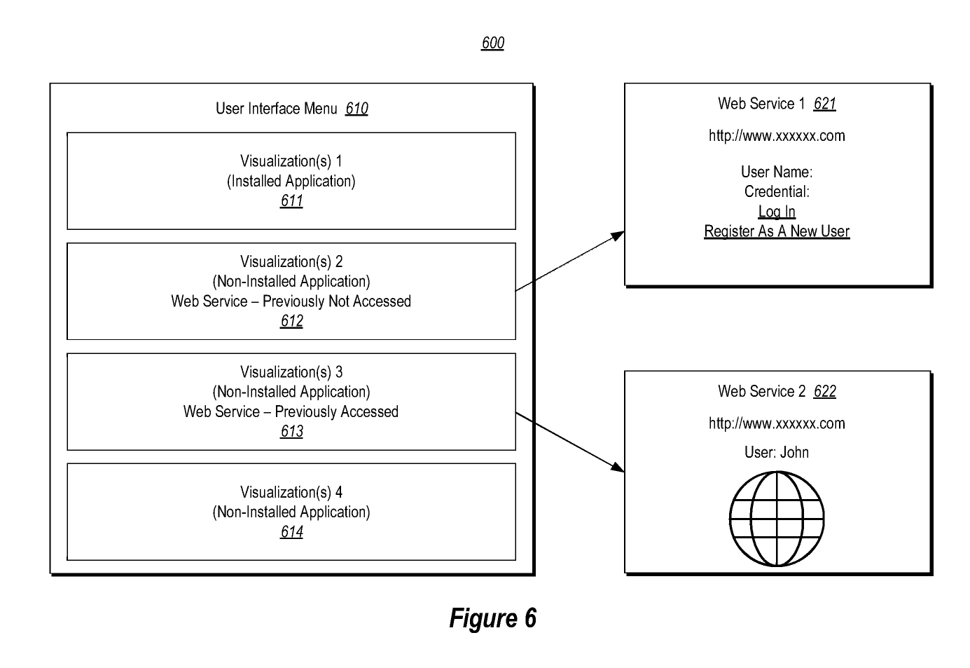

FIG. 6 further illustrates an environment 600 in which a user interface menu 610 is presented that includes visualizations of non-installed web services applications. The user interface menu 610 is an example of the user interface menu 350 of FIG. 3 or the user interface menu 230 of FIG. 2. The purpose of FIG. 6 is to illustrate what could happen when the user selects a web service as a content sharing application depending on whether or not the user has previously accessed that web service.

For instance, user interface menu 610 includes visualization set 611 through 614. The visualization set 611 have one or more visualizations that are each associated with an installed application. Each of the visualization sets 612 through 614 are associated with a corresponding set of one or more non-installed application(s). As illustrated, each visualization in visualization set 612 is associated with a web service that has not been accessed by the user previously; each visualization in visualization set 613 is associated with a web service that has been accessed by the user previously; and each visualization in visualization set 614 is associated with a non-installed application that is not a web service.

When a user interacts with one of the visualizations in visualization set 612, the credential manager 520 identifies that the web service associated with the visualization has not been previously accessed by the user. Thereafter, the computing system directs the user to the web service without automatically trying to log in to the web service. For instance, as illustrated, the initial user interface of the web service 621 may ask a user to log in or register as a new user. When a user interacts with one of the visualizations in visualization set 613, the credential manager 520 identifies that the web service associated with the visualization has been previously accessed by the user, and the system directs the user to the web service 622, whereupon the computing system automatically logs in with the previously stored user information. For instance, as illustrated, the user interface of the web service 622 may show the user's name as John, and other content information associated with the user John.

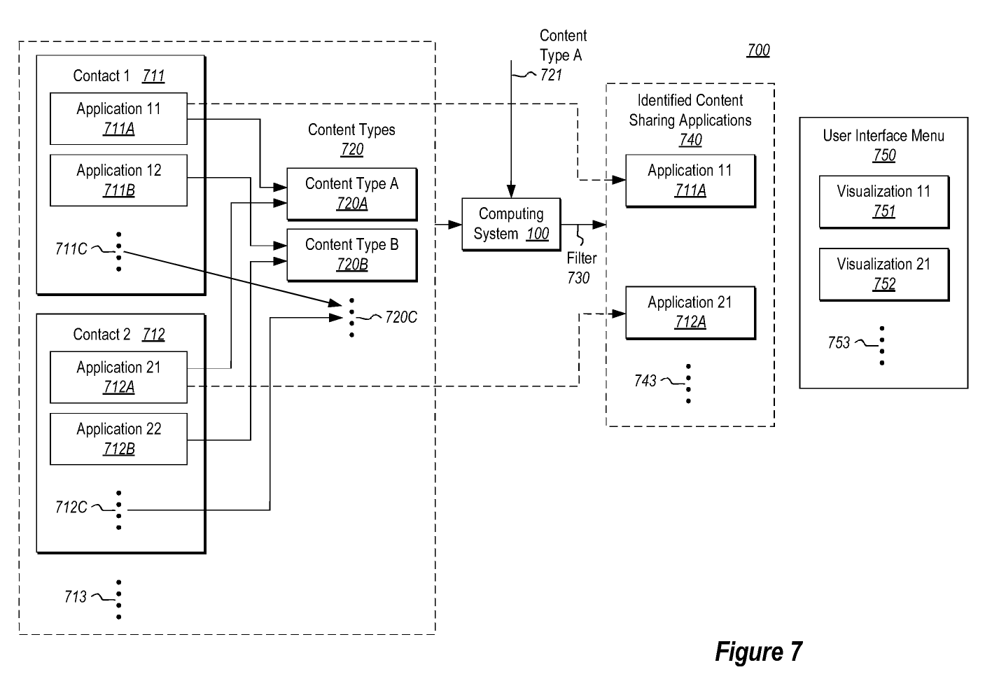

As illustrated in FIG. 3, the computing system could include additional identifying criteria when selecting the content sharing applications to be presented in the user interface menu. One of the illustrated additional criteria may be based on the identity 334 of the content sharing applications that are used by one or more of the user's contacts. FIG. 7 further illustrates an environment 700 with an associated data flow showing how content may be shared based on this criterion.

As illustrated in FIG. 7, the computing system identifies the content sharing applications that the user's contacts use. For instance, as illustrated, contact 711 (also referenced as “Contact 1”) uses content sharing application 711A through 711C (also references as “Application 11,” “Application 12”, and “Application 13”, respectively). The ellipses 711C represents a flexible number of the content sharing applications that contact 711 may use. The number may be zero, one or more. Similarly, contact 712 (also referenced as “Contact 2”) uses content sharing application 712A through 712C (also referenced as “Application 21”, “Application 22”, and “Application 23”, respectively). The ellipses 712C also represents a flexible number of the content sharing applications that contact 712 may use. The number also may be zero, one or more. The ellipses 713 represents that there may be more or many more contacts that use different content sharing applications. Alternatively, the ellipses 713 also represents a flexible number of the contacts and a flexible number of the content sharing applications that the contacts use. There may only be zero or one contact, or zero or one contact sharing applications that the user's contacts use.

The computing system 100 first detects the content type 720 of the content that the user is accessing. In a particular example that follows, assume that the computing system identifies (as represented by arrow 721) the content type is as being content type A. Accordingly, the computing system detects the content sharing applications that one or more user's contacts use, and filters 730 out the applications that enables content sharing of content type A. Assume that application 711A of contact 711 and application 712A of contact 712 enable content sharing of content type A; application 711B of contact 712 and application 712B of contact 712 enable content sharing of content type B; application 711C of contact 711 and application 713C of contact 712 enable content sharing of content type C; and so forth. As illustrated in FIG. 7, the computing system filters 730 out application 711A and application 712A, which enable content sharing of content type A. Finally, the system generates the user interface menu 750 and populates multiple visualizations, each of which being associated with the applications that are used by one or more of the user's contacts and enable the type of the content the user is accessing.

In the particular example, the user interface menu 750 populates visualizations 751 and 752, each of which is associated with application 711A and 712A. The ellipses 753 and 743 represent that there may be more content sharing applications that are not identified from the user's contacts, and each of the visualizations in visualization set 753 is associated with each of the content sharing applications in 743. The ellipses 743 and 753 also represent flexibility in the number of other content sharing applications 740 and a associated visualizations 750, respectively. The number may be zero, one, more or many more. Each of the applications associated with one of the visualizations in the user interface menu 750 may be installed or non-installed. At least one of the visualizations represents a non-installed application. The content sharing applications 740 of FIG. 7 represents an example of the content sharing applications 220 of FIG. 2. Furthermore, the user interface menu 750 represents an example of the user interface menu 230 of FIG. 2.

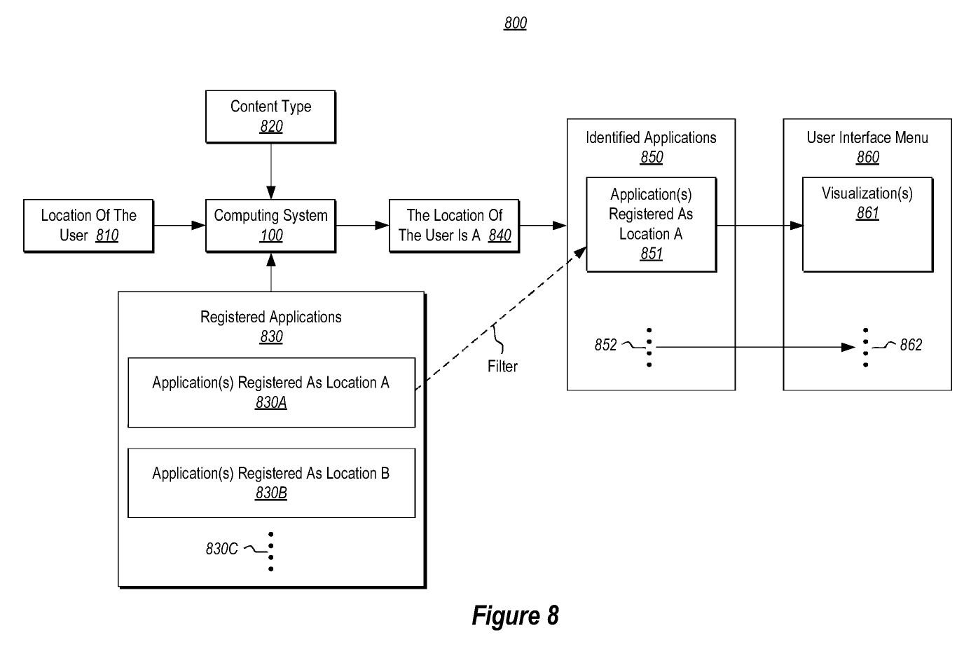

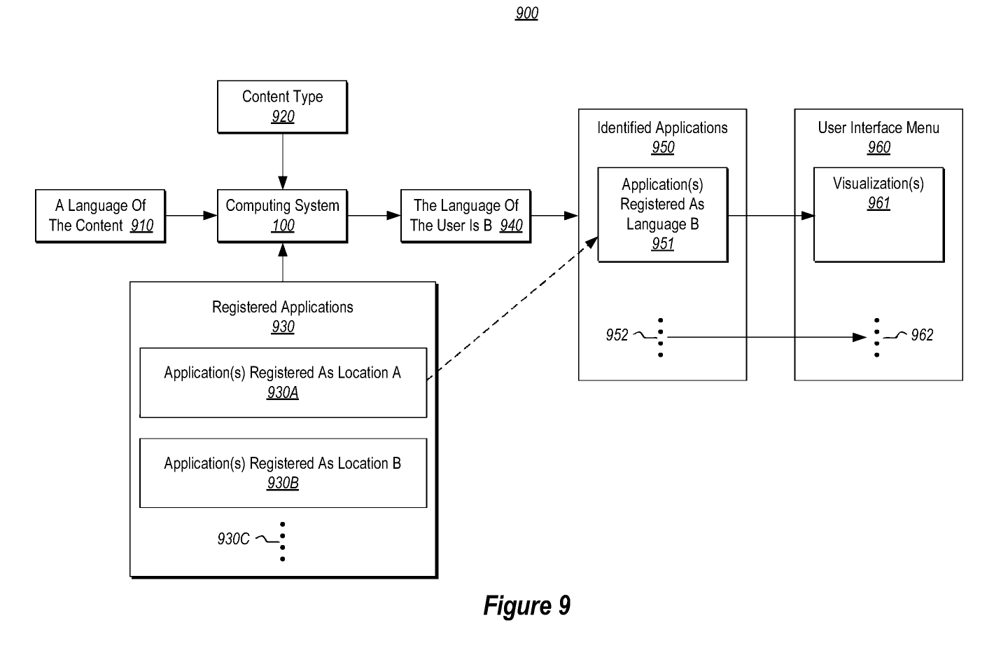

As illustrated in FIG. 3, the computing system could also use the region 333 of the user and the language 331 of the content being accessed as an additional selection criterion to select content sharing applications to be populated in the user interface menu 350. FIGS. 8 and 9 further illustrate this in more detail.

FIG. 8 illustrates an environment 800 that represents an example of the environment 200 of FIG. 2. For instance, the identified applications 850 of FIG. 8 represent an example of the content sharing applications 220 of FIG. 2. Furthermore, the user interface menu 860 is an example of the user interface menu 230 of FIG. 2. The environment 800 also includes a registered collection 830 of applications that are registered as associated with various locations. For instance, the registered collection 830 includes the identity of application set 830A through application set 830C. Each application in application set 830A is registered as corresponding to location A; each application in application set 830B is registered as corresponding to location B. There may be a flexible number of applications in each of the application set 830A and 830B, such as zero, one or more. The ellipses 830C represent that there may be many more a registered locations, and accordingly, there may be a flexible number of applications associated with each of the additional locations.

As illustrated in FIG. 8, the computing system may obtain a location of the user 810, and then identify (from the registered collection 830) a list of the content sharing applications that enable sharing of content of the content type 820. The computing system 100 filters out the applications that are registered as location A, and generates the user interface menu 860 including visualization set 861. Each visualization in visualization set 861 is associated with a content sharing application 851 that is registered as location A. The ellipses 862 represent one or more other visualizations that are each associated with a content sharing application that is within the identified content sharing applications that are not registered as corresponding location A (as represented by ellipses 853).

FIG. 9 illustrates an environment 900 that represents an example of the environment 200 of FIG. 2. For instance, the identified applications 950 of FIG. 9 represents an example of the content sharing applications 220 of FIG. 2. Furthermore, the user interface menu 960 is an example of the user interface menu 230 of FIG. 2. The environment 900 also includes a registered collection 830 of applications that are registered as associated with various languages. For instance, the registered collection 930 includes the identity of application set 930A through application(s) 930C. Each application in application set 930A is registered as corresponding to language A; each application in application set 930B is registered as corresponding to language B. There may be a flexible number of applications in each of the application set 930A and 930B, such as zero, one or more. The ellipses 930C represent that there may be many more a registered languages, and accordingly, there may be a flexible number of applications associated with each of the additional languages.

As illustrated in FIG. 9, the computing system may obtain a language of the user 910, and then identify (from the registered collection 930) a list of the content sharing applications that enable sharing of content of the content type 920. The computing system 100 filters out the applications that are registered as language B, and generates the user interface menu 960 including visualization set 961. Each visualization in visualization set 961 is associated with a content sharing application 951 that is registered as language B. The ellipses 962 represent one or more other visualizations that are each associated with a content sharing application that is within the identified shared content applications that are not registered as corresponding language B (as represented by ellipses 853).

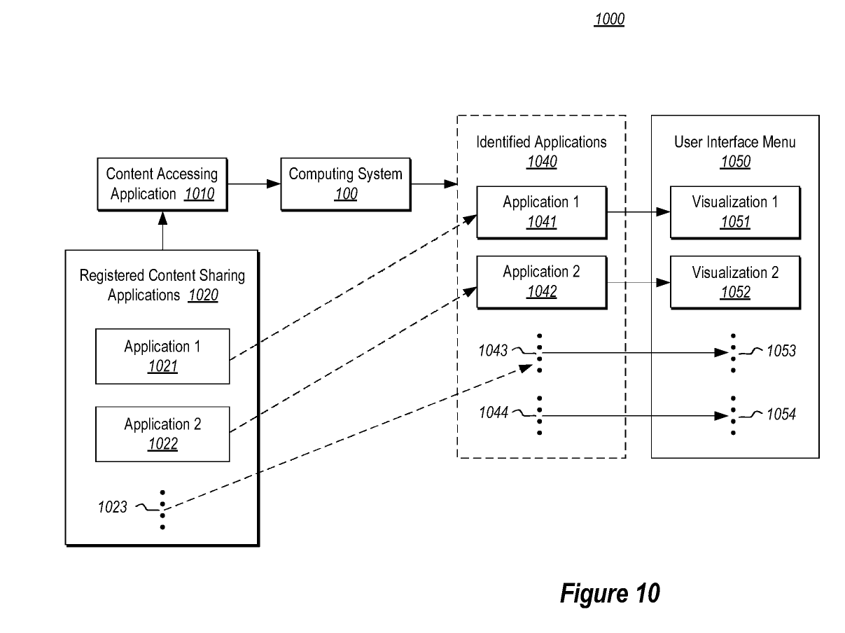

Finally, the computing system 100 may allow a content accessing application itself (e.g., via declarations or code provided by the author of the content accessing application) to register a preferred set of one or more corresponding content sharing applications to be used when sharing content of a particular type by the content accessing application. FIG. 10 illustrates an environment 1000 that is similar to the environment 200 of FIG. 2 but includes data flows that show how the content accessing applications may influence the choice of content sharing applications. For instance, identified applications 1040 is an example of the content sharing applications 220 of FIG. 2, and the user interface menu 1050 is an example of the user interface menu 230 of FIG. 2.

Referring to FIG. 10, a content accessing application 1010 may register an identity of one or more corresponding content sharing applications 1020. In the illustrated example, the content sharing applications to be registered include applications 1021 and 1022. The ellipses 1023 represent that there may be a flexible number of registered corresponding content sharing applications. The number may be zero, one or more. When a user is accessing content through application 1010, the computing system detects one or more corresponding content sharing applications that are registered with application 1010. Accordingly, the computing system creates the user interface menu 1050 and includes one or more visualizations 1051 through 1053, each of which is associated with one of the corresponding applications 1041 through 1043 registered with the content accessing application 1010.

As illustrated, assume visualization 1051 is associated with 1041; visualization 1052 is associated with 1042 and visualization 1053 is associated with application 1043. Similar to the ellipses 1023, the ellipses 1043 and 1053 represent that there may be a flexible number of identified applications and associated visualizations, respectively. The number may be zero, one or more. The ellipses 1044 further represent that the computing system may also identify one or more other content sharing applications that are not registered with the content accessing application 1010. The visualization 1054 represents one or more visualizations, each of which being associated with one of the content sharing applications 1044 that are not registered with the content accessing application 1010. The ellipses 1044 and 1054 also represent that the number of the applications or the visualizations may be flexible, such as zero, one or more.

The computing system 100 may enable sharing of content of multiple types. FIG. 11 illustrates an environment 1100 in which the computing system detects (as represented by arrow 1111) the type of content that the user is accessing, and further determines (as represented by arrow 1121) whether the type of the content is one of the types for which the computing system 100 enables content sharing. As illustrated, the supported content types 1120 may include text content type 1121 and multimedia content type 1122. The ellipses 1123 represent that there may be zero, one or more content types categories that the computing system 100 may support, and there may be one or more content types in each category that the system 100 may support. Image content type 1122A, audio content type 1122B, video content type 1122C, web address content type 1122D, and web page content type 1122E are listed in the category of multimedia content type 1122. The ellipses 1122 F represent that there may be zero, one or more other multimedia content type that the system 100 may support.

Accordingly, the principles described herein provide a model for a computing system to present a user interface menu including multiple visualizations, each of which is associated with a content sharing application, which allows a user to share content that the user is accessing. At least one of the content sharing applications associated with one of the visualizations is a non-installed application, which allows a user to share the content not only with one or more installed applications, but also with one or more non-installed applications.

The computing system identifies the non-installed applications based on the type of the content that the user is accessing, for instance, text content type, image content type, audio content type, video content type, web address content type, web page content type, other multimedia content type, and so forth. Furthermore, the system may identify the non-installed applications based on other additional criteria, for instance, the user's location, the language of the content, the applications that one or more of the user's contacts use, the content accessing application that the user is using, the web services the user previously accessed, and so forth.

This allows the number of potential content sharing applications presented to the user to be augmented to include web services and non-installed applications. This further provides a greater likelihood of interest of the user in sharing via these additional options for content sharing applications. Thus, the principles described herein provide a technical advancement in the state of the art in sharing content over networks.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for a computing system to present to a user a plurality of applications that enable the user to share a type of content that the user has accessed, the method comprising:
an act of providing a user interface for accessing content;
an act of detecting the type of the content that a user is accessing;
an act of identifying a plurality of applications that enable the user to share the detected type of the content, at least one of the plurality of applications not being installed in the computing system;
an act of displaying a user interface menu that includes a visualization of each of the plurality of applications including the at least one non-installed application;
an act of detecting user selection of a non-installed application visualized in the user interface menu; and
in response to the act of selecting, an act of providing the user sharing access to the non-installed application.

2. The method in accordance with claim 1, the at least one non-installed application comprising a web service, the act of providing the user sharing access comprising an act of directing the user to the web service.

3. The method in accordance with claim 2, the method further comprising:
an act of tracking the web services the user has logged into; and
an act of storing the user login information of the web services;
the act of directing the user to the web service comprising an act of logging the user into the web service.

4. The method in accordance with claim 1, the method further comprising:
an act of identifying a content sharing application that one or more contacts of the user uses;
the act of identifying a plurality of applications comprising including the content sharing application in the plurality of applications that are visualized to the user.

5. The method in accordance with claim 1, the method further comprising:
an act of identifying the location of the user;
an act of identifying an application that corresponds to the identified location of the user; and
the act of identifying a plurality of applications comprising including the identified application that corresponds to the identified location of the user in the plurality of applications that are visualized to the user.

6. The method in accordance with claim 1, the method further comprising:
an act of identifying a language of the content that the user accesses;
an act of identifying an application that corresponds to the identified language of the content; and
the act of identifying a plurality of applications comprising including the identified application that corresponds to the language of the content in the plurality of applications that are visualized to the user.

7. The method in accordance with claim 1, further comprising:
an act of identifying one or more registered compatible content types for an application that is installed on the computing system, the registered compatible content types being provided at authoring time of the application installed on the computing system; and
an act of determining that the detected type of the content that the user is accessing falls within the one or more registered compatible content types;
the act of identifying a plurality of applications comprising including the installed application in the plurality of applications that are visualized to the user.

8. The method in accordance with claim 1, the type of content being a multimedia content type.

9. The method in accordance with claim 8 the multimedia content type selected from the group consisting of a text content type, an image content type, an audio content type, and a video content type.

10. The method in accordance with claim 1, the type of content being a web address content type.

11. The method in accordance with claim 1, the type of content being a web page content type.

12. A computer system, comprising:
one or more processors; and
one or more computer-readable storage media having stored thereon computer-executable instructions that are executable by the one or more processors to cause the computer system to implement a method for configuring a computing system to cause a computing logic to perform an action, the method comprising:
an act of providing a user interface for accessing content;
an act of detecting the type of the content that a user is accessing;
an act of identifying a plurality of applications that enable the user to share the detected type of the content, at least one of the plurality of applications not being installed in the computing system;
an act of displaying a user interface menu that includes a visualization of each of the plurality of applications including the at least one non-installed application;
an act of detecting user selection of a non-installed application visualized in the user interface menu; and
in response to the act of selecting, an act of providing the user sharing access to the non-installed application.

13. The computer system in accordance with claim 13, the at least one non-installed application comprising a web service, the act of providing the user sharing access comprising an act of directing the user to the web service.

14. The computer system in accordance with claim 14, the method further comprising:
an act of tracking the web services the user has logged into; and
an act of storing the user login information of the web services;
the act of directing the user to the web service comprising an act of logging the user into the web service.

15. The computer system in accordance with claim 13, the method further comprising:
an act of identifying a content sharing application that one or more contacts of the user uses;
the act of identifying a plurality of applications comprising including the content sharing application in the plurality of applications that are visualized to the user.

16. The computer system in accordance with claim 13, the method further comprising:
an act of identifying the location of the user;
an act of identifying an application that corresponds to the identified location of the user; and
the act of identifying a plurality of applications comprising including the identified application that corresponds to the identified location of the user in the plurality of applications that are visualized to the user.

17. The computer system in accordance with claim 13, the method further comprising:
an act of identifying a language of the content that the user accesses;
an act of identifying an application that corresponds to the identified language of the content; and
the act of identifying a plurality of applications comprising including the identified application that corresponds to the language of the content in the plurality of applications that are visualized to the user.

18. The computer system in accordance with claim 13, further comprising:
an act of identifying one or more registered compatible content types for an application that is installed on the computing system, the registered compatible content types being provided at authoring time of the application installed on the computing system; and
an act of determining that the detected type of the content that the user is accessing falls within the one or more registered compatible content types;
the act of identifying a plurality of applications comprising including the installed application in the plurality of applications that are visualized to the user.

19. The computer system in accordance with claim 13, the type of content being a multimedia content type.

20. A computer program product comprising one or more physical computer-readable storage media having thereon one or more computer-executable instruction(s) that, when executed by one or more processors of the computing system, cause the computing system to implement a method for configuring a computing system to cause a computing logic to perform an action, the method comprising:
an act of providing a user interface for accessing content;
an act of detecting the type of the content that a user is accessing;
an act of identifying a plurality of applications that enable the user to share the detected type of the content, at least one of the plurality of applications not being installed in the computing system;
an act of displaying a user interface menu that includes a visualization of each of the plurality of applications including the at least one non-installed application;
an act of detecting user selection of a non-installed application visualized in the user interface menu; and
in response to the act of selecting, an act of providing the user sharing access to the non-installed application.
